(19) United States
(12) Patent Application Publication
(10) Pub. No.: US 2014/0078055 A1
(43) Pub. Date: Mar. 20, 2014

(54) TOUCH SENSOR INTEGRATED WITH A TRACK POINTER

(71) Applicant: MOTOROLA MOBILITY LLC, Libertyville, IL (US)

(72) Inventors: Mark F. Valentine, Kenosha, WI (US); David B. Cranfill, Allen, TX (US)

(73) Assignee: MOTOROLA MOBILITY LLC, Libertyville, IL (US)

(21) Appl. No.: 13/622,054

(22) Filed: Sep. 18, 2012

(51) Int. Cl. G06F 3/033; G06F 3/041; G06F 3/02

(52) U.S. Cl. 345/157

(57) ABSTRACT

A track pointer including a touchpad. The track pointer can be operable in at least two states. In a first of the states, the touchpad can be activated to detect movement of a human appendage across the touchpad or above the touchpad and generate a corresponding first signal that causes corresponding movement of a cursor presented on a display. In a second of the states, the touchpad can be deactivated, and the track pointer can be configured to detect movement of the track pointer by the human appendage and generate a corresponding second signal that causes corresponding movement of the cursor presented on the display.

### BACKGROUND OF THE INVENTION

A touchpad, sometimes referred to as a trackpad, is a pointing device commonly used on laptop computers as a substitute for a mouse. A touchpad features a planar surface that translates the position and motion of a user's finger to a relative position and motion on a display. The planar surface can operate using a variety of technologies, for example using capacitive sensing or conductance sensing. Oftentimes one or more buttons are positioned proximate to the touchpad to receive user inputs, commonly referred to as “right click,” “left click” and “double click,” to select objects, launch menus, and initiate other programmatic actions. Sometimes, such programmatic actions can be initiated in response to finger taps being detected on the planar surface.

### BRIEF DESCRIPTION OF THE DRAWINGS

FIG. 1 depicts a keyboard including a touchpad integrated with a track pointer in accordance with an arrangement described herein.

FIG. 2 is an enlarged side view of the track pointer of FIG. 1 in accordance with an arrangement described herein.

FIG. 3 is an enlarged view of internal components of the track pointer of FIG. 2.

FIG. 4 is another enlarged view of internal components of the track pointer of FIG. 2.

FIG. 5 depicts an enlarged view of a first ratchet member in accordance with an arrangement described herein.

FIG. 6 depicts an enlarged view of a second ratchet member in accordance with an arrangement described herein.

FIG. 7 depicts an enlarged section view of a third ratchet member in accordance with an arrangement described herein.

FIG. 8 depicts an enlarged view of a touchpad in accordance with an arrangement described herein.

FIG. 9 depicts a capacitive touch sensor in accordance with an arrangement described herein.

FIG. 10 is a flowchart depicting a method of operating a track pointer in accordance with an arrangement described herein.

### DETAILED DESCRIPTION

While the specification concludes with claims defining features of the embodiments described herein that are regarded as novel, it is believed that these embodiments will be better understood from a consideration of the description in conjunction with the drawings. As required, detailed arrangements of the present embodiments are disclosed herein; however, it is to be understood that the disclosed arrangements are merely illustrative, example embodiments, which can be embodied in various forms. Therefore, specific structural and functional details disclosed herein are not to be interpreted as limiting, but merely as a basis for the claims and as a representative basis for teaching one skilled in the art to variously employ the present embodiments in virtually any appropriately detailed structure. Further, the terms and phrases used herein are not intended to be limiting but rather to provide an understandable description of the present arrangements.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

Arrangements described herein relate to integration of a touchpad with a track pointer. In one arrangement, the track pointer can be a component of a keyboard, though the present embodiments are not limited in this regard. The track pointer can be configured to be operable between at least two distinct states. In a first state, operation of the touchpad is disabled, and the track pointer can receive user inputs that tactilely move the track pointer. In a second state, operation of the touchpad is enabled. Rather than recognizing user inputs tactilely moving the track pointer, user inputs can be recognized via the touchpad integrated into the track pointer. In the second state, the track pointer can be configured to be stationary, or substantially stationary. Indeed, in the second state, the track pointer can be configured to move so that such movement is undetectable by a user, or barely detectable by a user, though the present embodiments are not limited in this regard.

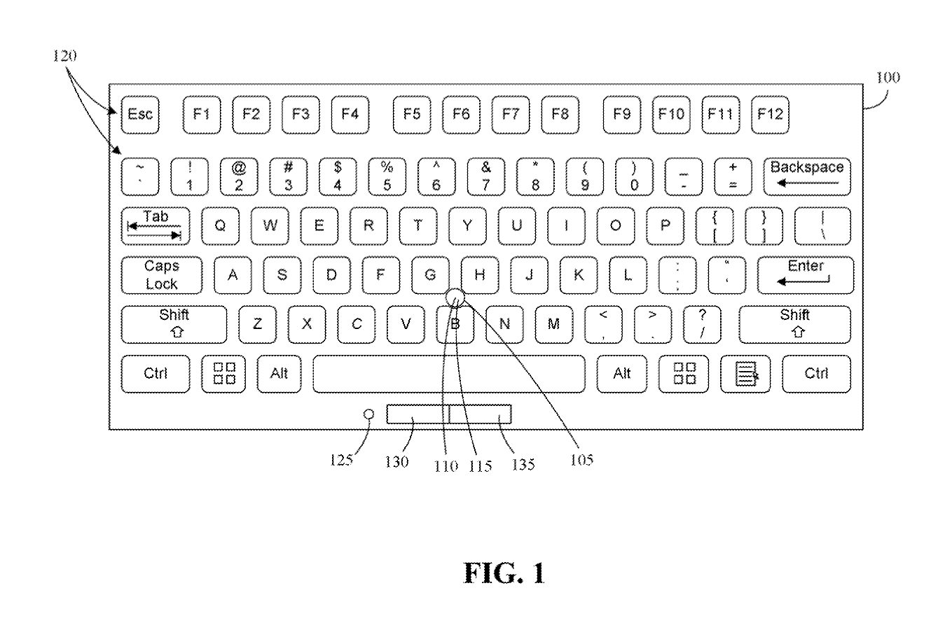

FIG. 1 depicts a keyboard 100 including a touchpad 110 integrated with a track pointer 105 in accordance with an arrangement described herein. The touchpad 110 can be positioned at or near a top of the track pointer 105. For example, the touchpad 110 can be integrated with a planar material defining a top surface 115 of the track pointer 105. As used herein, the term “integrated with” means attached to or embedded within. Thus, the touchpad 110 can be disposed on the top surface 115, within the planar material below the top surface 115, or disposed on a side of the planar material opposite the top surface 115. In another example, the touchpad 110 can be disposed in the track pointer 105 below the planar material.

Regardless, the touchpad 110 can be selectively configured to detect touches by a human appendage (e.g., a finger) on the top surface 115, or movements of the human appendage above the top surface 115, and generate a corresponding signal from the keyboard 100 that causes corresponding movement of a cursor presented on a display. In illustration, the track pointer 105 can be operable between at least two states. In a first state, the touchpad can be activated to detect movement of a human appendage across the touchpad 110 or above the touchpad 110 and generate a corresponding first signal that causes corresponding movement of a cursor presented on a display. In a second of the state, the touchpad 110 can be deactivated, and the track pointer 105 can be configured to detect movement of the track pointer 105 by the human appendage and generate a corresponding second signal that causes corresponding movement of the cursor presented on the display.

In one arrangement, the touchpad 110 can include a capacitive touch sensor. In another arrangement, the touchpad 110 can include an optical touch sensor. Not only can a capacitive touch sensor or an optical touch sensor detect touches directly on the touchpad 110, such sensors can be configured to detect gestures above, but not actually touching, the touchpad 110. In an arrangement in which an optical sensor is used, the optical sensor can detect visible electromagnetic wavelengths, or wavelengths not normally visible to a human being. For example, the optical sensor can detect infrared (IR) wavelengths. Further, both capacitive and optical touch sensors can be configured to detect touches or gestures through an intervening medium, such as a planar material which may be covering such sensors. In illustration, when an optical sensor is used, the planar material can be transparent, or substantially transparent, to electromagnetic waves within a particular frequency band (e.g., a non-visible frequency band), while being opaque or semi-opaque to electromagnetic waves in another frequency band (e.g., a visible frequency band). The present arrangements are not limited in this regard, however.

The keyboard 100 can be any keyboard that includes a plurality of keys 120, for example a conventional keyboard in a QWERTY or Dvorak layout. The keyboard 100 further can include a keypad (not shown), cursor movement keys (i.e., arrow keys) (not shown), and/or any number of other keys.

The user can toggle the track pointer 105 between the first and second states. In one arrangement, the user can toggle the track pointer 105 between the first and second states by selecting a user control, such as an icon, button, or the like, in a user interface presented on the display. In another arrangement, the user can toggle the track pointer 105 between the first and second states by selecting a key 120, a key sequence and/or a plurality of keys 120 of the keyboard 100. In a further arrangement, the user can toggle the track pointer 105 between the first and second states by selecting one or more buttons 130, 135. Such buttons 130, 135 will be further described herein. In yet another arrangement, the user can toggle the track pointer 105 between the first and second states by depressing the top surface 115 of the track pointer 105, as also will be described herein.

An indicator 125, such as a light (e.g., a light emitting diode (LED)), can be integrated into the keyboard 100 to indicate whether the touchpad 110 is active. In lieu of, or in addition to, such indicator 125, a message can be provided by a processing system to which the keyboard 100 is attached to indicate whether the touchpad 110 is active. For instance, the processing system can present a word balloon or other suitable indicator onto a display.

Optionally, the keyboard 100 can include one or more buttons 130, 135 to receive user inputs (e.g., left click and right click and double click) to select objects, launch menus, and initiate other programmatic actions. In addition to, or in lieu of, the buttons 130, 135, such user inputs can be received by the touchpad 110, for example as finger taps. In illustration, a single finger tap in the touchpad 110 can be interpreted as a left click, and two sequential finger taps can be interpreted as a double click.

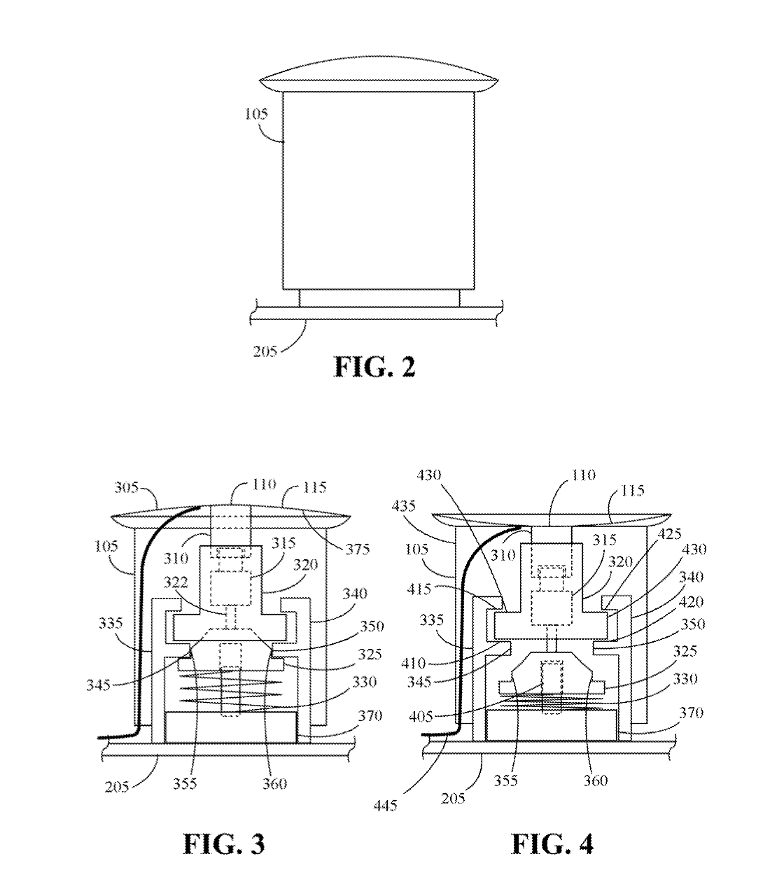

FIG. 2 is an enlarged side view of the track pointer 105 of FIG. 1 in accordance with one arrangement described herein. The track pointer 105 can be attached to the keyboard, for example to a printed circuit board 205 or other structure of the keyboard. As noted, however, the present arrangements are not limited in this regard. For example, the track pointer 105 can be integrated with any other suitable user input device. The track pointer 105 generally can be cylindrical in shape, though the present arrangements are not limited to such.

FIG. 3 is an enlarged view of internal components of the track pointer 105 of FIG. 2. Specifically, FIG. 3 represents the track pointer 105 positioned to operate in the first state in which the touchpad 110 is activated to detect movement of a human appendage across the touchpad or above the touchpad and generate a corresponding signal. In this state, the top surface 115 can be convex in shape. In this regard, the track pointer 105 can include planar material 305 defining the top surface 115. The planar material can include an elastomer material configured to stretch and retract, as appropriate, to change between convex and concave shapes without significant degradation of functionality.

The components of the track pointer 105 generally can be cylindrical in shape, though the present arrangements are not limited in this regard. As such, elements, such as the side members 335, 340 (described hereinafter) may be respective portions of a single member of the track pointer 105, or can be distinct members provided in the track pointer 105.

The track pointer 105 also can include a plurality of ratchet members 310, 315, 320. Collectively, the ratchet members 310-320 can be operable to configure the track pointer 105 between the first state and the second state in response to receiving the user input via the human appendage. Further, the plurality of ratchet members 310-320 can maintain the track pointer 105 in the first state or the second state until a next user input via the human appendage is received. Via the ratchet members 310, 315 (and, in one non-limiting arrangement, a rod 322 of the plunger 325), the planar material 305 can be mechanically coupled to a plunger 325. In the first state, a spring 330 can bias the plunger 325 into a position in which side members 335, 340 of the track pointer 105 prevent, or significantly limit, horizontal movement of the plunger 325. For example, portions 345, 350 of the side members 335, 340 can engage respective portions 355, 360 of the plunger 325. Accordingly, the track pointer 105 can remain stationary, or substantially stationary, with respect to horizontal movement, even when movement of the human appendage across or above the touchpad 110 occurs (e.g., across the top surface 115). Thus, in the example, the track pointer 105 does not pivot with respect to a track pointer encoder 370 configured to detect horizontal movement (e.g., pivoting) of the track pointer 105. Further, when the track pointer 105 is in the first state, the track pointer encoder 370 can be disabled.

The touchpad 110 can be integrated with the planar material 305 (e.g., on the top surface 115, within the planar material 305, on a surface 375 of the planar material 305 opposite the top surface 115) or located elsewhere within the track pointer 105. For example, a touchpad sensor for the touchpad 110 can be integrated within the ratchet member 310, or elsewhere within the track pointer 105.

To change the track pointer 105 from the first state to the second state in which the touchpad 110 is deactivated and the track pointer encoder 370 is configured to detect movement of the track pointer 105, the user can depress, for example using an appendage, the top surface 115 of the track pointer 105 to operate the track pointer 105 between the first and second states. By depressing the top surface 115, the top surface 115 can change from a convex shape to a concave shape, and the plunger 325 can be lowered with respect to the side members 335, 340, thereby disengaging the portions 355, 360 of the plunger 325 from the portions 345, 350 of the side members 335, 340. Accordingly, in the second state, the track pointer 105 is free to move horizontally, and thus free to pivot with respect to the track pointer encoder 370, for example with respect to a pivot point within the track pointer encoder 370. Moreover, the ratchet members 310-320 can maintain the track pointer 105 in the second state until the user again depresses the top surface 115 of the track pointer 105.

FIG. 4 is another enlarged view of internal components of the track pointer 105 in which the track pointer 105 is positioned to operate in the second state. When the track pointer 105 is positioned to operate in the second state, the touchpad 110 can be deactivated, and the track pointer encoder 370 can be activated. In one arrangement, one or more sensors (not shown) can detect which state the track pointer 105 presently is in, and communicate corresponding signals to a processor or controller suitable configured to activate and deactivate the touchpad 110 and/or the track pointer encoder 370. In another arrangement, the touchpad 110 can detect which state the track pointer 105 presently is in, and communicate corresponding signals to a processor or controller suitable configured to activate and deactivate the touchpad 110 and/or the track pointer encoder 370. In this arrangement, the touchpad 110 need only be activated/deactivated with respect to detecting user inputs, but can continuously remain activated with respect to detecting the state of the track pointer 105.

In the second state, the portions 355, 360 of the plunger 325 can be disengaged from the portions 345, 350 of the side members 335, 340, thereby allowing the track pointer 105 to move horizontally, and thus pivot with respect to the track pointer encoder 370. Accordingly, the track pointer encoder 370 can detect horizontal movement of the track pointer 105, and generate corresponding signals (e.g., communicated to a processor or controller).

Specifically, via the ratchet members 310, 315, the plunger 325, and a rod 405 that mechanically couples the plunger 325 to the track pointer encoder 370, the track pointer encoder 370 can detect pivoting of the rod 405, and thus the horizontal movement of the track pointer 105 when the user pivots the track pointer 105 using an appendage. The rod 405 can slidably engage the plunger 325 to allow for the plunger 325 to move vertically, with respect to the track pointer encoder 370, when the track pointer changes between the first and second states. The spring 330 can bias the track pointer 105 to maintain the track pointer 105 in the second state until the user again depresses the top surface 115, upon which the track pointer 105 can revert back to the first state depicted in FIG. 3.

To facilitate proper operation of the ratchet members 310-320, vertical and/or rotational movement of the ratchet member 320 can be limited, while the ratchet members 310, 315 are free to move vertically within the ratchet member 320. Moreover, the second ratchet member 315 can be free to rotate within the ratchet member 320 each time the user depresses the top surface 115, thereby activating the ratcheting functionality provided by the ratchet members 310-320.

To limit vertical movement of the ratchet member 320, the side members 335, 340 can include respective portions 410, 415, 420, 425 configured to engage a lower portion 430 of the ratchet member 320. Nonetheless, sufficient room may be provided so that the side members 335, 340 do not interfere with horizontal movement of the ratchet member 320 when the user pivots the track pointer 105 within the pivot range the track pointer 105 is intended to operate while in the second state. The ratchet member 310 can engage the ratchet member 320 to prevent rotation of the ratchet member 320 about a longitudinal axis of the track pointer 105 (e.g., the axis generally perpendicular to the printed circuit board 205). For example, the ratchet member 310 can be attached to the planar material 305, and thus coupled to further structure 435 of the track pointer 105. The planar material 305 can prevent the ratchet member 310 from rotating, and thus prevent the ratchet member 320 from rotating.

A flex cable 445 can be provided in the track pointer 105 to communicatively link the touchpad 110 to a suitable processor or controller (not shown) that receives signals from the touchpad 110 to cause corresponding movement of a cursor on a display. The processor or controller also can recognize other inputs detected via the touchpad 110, such as single taps, double taps, etc., and in response cause corresponding programmatic actions. The processor or controller also can enable/disable the touchpad 110 based on whether the track pointer 105 presently is in the first state or the second state. The processor or controller can detect whether the track pointer 105 presently is in the first state or the second state from signals received from the touchpad 110 or signals received from another sensor (not shown).

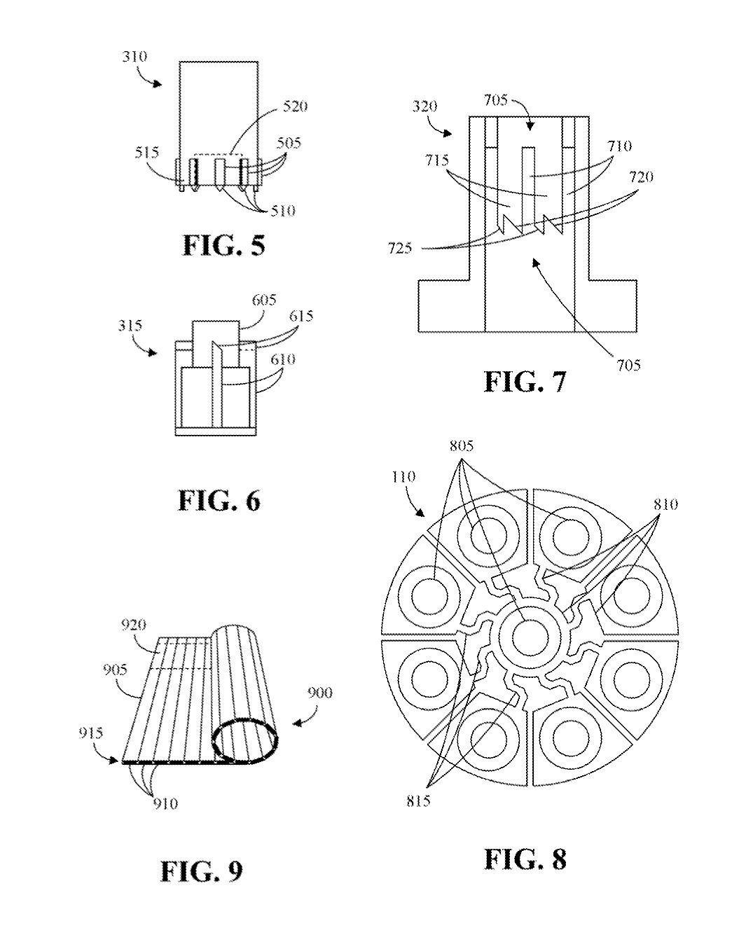

FIG. 5 depicts an enlarged view of the ratchet member 310 (hereinafter “first ratchet member”) in accordance with one arrangement described herein. The first ratchet member 310 can be generally cylindrical in shape, and can include a plurality of keys 505 configured to engage key slots defined in the ratchet member 320 (hereinafter “third ratchet member”). The first ratchet member 310 further can include a plurality of teeth 510 configured to engage teeth of the ratchet member 315 (hereinafter “second ratchet member”). The keys 505 can be disposed around a periphery of the first ratchet member 310, for example at a lower portion 515 of the first ratchet member 310. The teeth 510 can extend below the lower portion 515. In one arrangement, the teeth 510 can be radially inset from the keys 505, though the present arrangements are not limited in this regard. Within the first ratchet member 310 a hole 520 can be defined to receive the second ratchet member 315.

FIG. 6 depicts an enlarged view of the second ratchet member 315 in accordance with one arrangement described herein. The second ratchet member 315 can be generally cylindrical in shape, and can include a portion 605 configured to engage the hole 520 defined in the first ratchet member 310 to receive the second ratchet member 315. The second ratchet member 315 can include a plurality of keys 610 disposed around a periphery of the second ratchet member 315. The keys 610 can be configured to engage the key slots defined in the third ratchet member 320. Each key 610 can include a respective tooth 615 configured to selectively engage teeth 510 of the first ratchet member 310. Specifically, each time the top surface of the track pointer is depressed, the second ratchet member 315 can rotate within the third ratchet member 320 to engage a new key slot, and thus each tooth 615 can engage a next tooth 510 of the first ratchet member 310. Bias provided by the spring of the track pointer can facilitate such ratcheting functionality.

FIG. 7 depicts an enlarged section view of the third ratchet member 320 in accordance with one arrangement described herein. The section view depicts geometrical features of an inner region 705 of the third ratchet member 320. The third ratchet member 320 also can be generally cylindrical in shape. The third ratchet member 320 can have defined, within the inner region 705, a plurality of key slots 710 configured to engage the respective keys 505, 610 of the first and second ratchet members 310, 315. The keys 505 of the first ratchet member 310 can prevent rotation of the third ratchet member 320 when the track pointer is operated between the first and second states.

The key slots 710 can be bounded by, and defined by, raised portions 715 of the third ratchet member 320. Each raised portion 715 can include a respective tooth 720 configured to engage a respective tooth 615 of the second ratchet member 315 when the track pointer is positioned to operate in the second state. Each raised portion 715 also can include a respective tooth 725 configured to engage a respective tooth 615 of the second ratchet member 315 to guide a respective key 610 into a respective key slot 710 when the track pointer is positioned to operate in the first state.

In illustration, each time the top surface of the track pointer is depressed the teeth 510 of the first ratchet member 310 can engage the teeth 615 of the second ratchet member 315 and move such teeth 615 to engage a next tooth 720, 725 of the third ratchet member 320. When the teeth 615 engage the teeth 720, the track pointer will be in the second state since the raised portion 715 prevents the keys 610 from engaging respective key slots 710. When the teeth 615 engage the teeth 725, the bias provided by the spring, and the diagonal shape of the respective teeth 615, 725, will move the keys 610 into respective key slots 710, thereby configuring the track pointer to be in the first state. In this regard, the second ratchet member 315 can be configured to freely rotate within the third ratchet member 320. The first ratchet member 310 need not rotate within the third ratchet member 320.

FIG. 8 depicts an enlarged view of a touchpad 110 in accordance with one arrangement described herein. The touchpad 110 can be configured to be integrated with the planar material defining the top surface of the track pointer. As noted, the touchpad 110 can be disposed on the top surface, on a side of the planar material opposite the top surface, or within the planar material.

The touchpad 110 can include a plurality of sensing elements 805, for example capacitive sensing elements. The sensing elements 805 can be electrically coupled to a controller (e.g., processor) via electrical circuits 810. The electrical circuits 810 can be flex circuits configured to maintain electrical conductivity between the plurality of sensing elements 805 and the controller that processes signals generated by the sensing elements 805 through repeated changes of the track pointer between the first state and the second state. In this regard, the electrical circuits 810 can include strain reliefs 815 configured to prevent failure of the electrical circuits 810 due to repeated cycling of the planar material between convex and concave shapes when the state of the track pointer is changed between the first and second states.

FIG. 9 depicts a capacitive touch sensor 900 in accordance with one arrangement described herein. In this example, the capacitive touch sensor 900 can include a flex printed circuit board 905 comprising a plurality of capacitive sensing elements 910 disposed at an end 915 of the flex printed circuit board 905. The flex printed circuit board 905 can be rolled into a spiral shape, and the end 915 of the flex printed circuit board 905 at which the plurality of capacitive sensing elements 910 are disposed can be positioned at or near the top of the track pointer. In one arrangement, the flex printed circuit board 905 can include at least one processor/controller 920 that processes signals generated by the capacitive sensing elements 910.

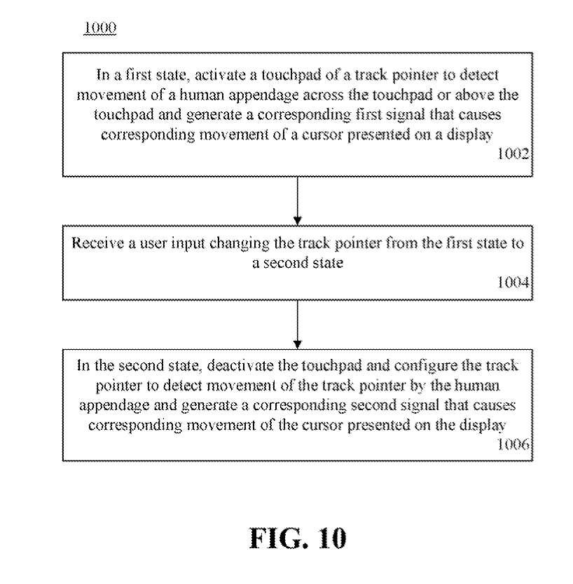

FIG. 10 is a flowchart depicting a method 1000 of operating a track pointer in accordance with an arrangement described herein. At step 1002, in a first state, a touchpad of the track pointer can be activated to detect movement of a human appendage across the touchpad or above the touchpad and generate a corresponding first signal that causes corresponding movement of a cursor presented on a display. At step 1004, a user input can be received changing the track pointer from the first state to a second state. At step 1006, in the second state, the touchpad can be deactivated and the track pointer can be configured to detect movement of the track pointer by the human appendage and generate a corresponding second signal that causes corresponding movement of the cursor presented on the display.

In the first state, the track pointer can remain at least substantially stationary with respect to horizontal movement when movement of the human appendage across or above the touchpad occurs. In the second state the track pointer can be free to pivot with respect to a pivot point, and pivoting of the track pointer can be detected by a track pointer encoder to generate the corresponding second signal. Further, in the first state the top surface of the track pointer can be convex in shape. In the second state the top surface of the track pointer can be concave in shape.

The flowchart and diagrams in the figures illustrate the architecture, functionality, and operation of possible implementations of systems, methods and computer program products according to various embodiments described herein. In this regard, each block in the flowchart may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present embodiments can be realized in hardware, or a combination of hardware and software. The present embodiments can be realized in a centralized fashion in one processor or in a distributed fashion where different elements are spread across several interconnected processors. Any kind of processor or other apparatus adapted for carrying out the methods described herein is suited. A typical combination of hardware and software can be a processor and memory having computer-readable (or computer-usable) program code that, when being loaded and executed by at least one processor, controls the processor such that it carries out the methods described herein.

The term “program code,” in the present context, means any expression, in any language, code or notation, of a set of instructions intended to cause a system having an information processing capability to perform a particular function either directly or after either or both of the following: a) conversion to another language, code or notation; b) reproduction in a different material form. The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one sensor, object, region, location, portion or the like from another sensor, object, region, location, portion or the like. Thus, an ordinal term used herein need not indicate a specific position in an ordinal series.

These embodiments can be embodied in other forms without departing from the spirit or essential attributes thereof. Accordingly, reference should be made to the following claims, rather than to the foregoing specification, as indicating the scope of the embodiments.

What is claimed is:

1. A keyboard comprising:
a track pointer integrated into the keyboard, the track pointer comprising a touchpad;
wherein:
the track pointer is operable in at least two states;
in a first of the states, the touchpad is activated to detect movement of a human appendage across the touchpad or above the touchpad and generate a corresponding first signal that causes corresponding movement of a cursor presented on a display; and
in a second of the states, the touchpad is deactivated, and the track pointer is configured to detect movement of the track pointer by the human appendage and generate a corresponding second signal that causes corresponding movement of the cursor presented on the display.

2. The keyboard of claim 1, wherein:
in the first state, the track pointer remains at least substantially stationary with respect to horizontal movement when movement of the human appendage across or above the touchpad occurs; and
in the second state the track pointer is free to pivot with respect to a pivot point, and pivoting of the track pointer is detected by a track pointer encoder to generate the corresponding second signal.

3. The keyboard of claim 1, wherein the track pointer is configured to receive a user input via the human appendage to operate the track pointer between the first state and the second state.

4. The keyboard of claim 3, wherein:
in the first state the top surface of the track pointer is convex in shape; and
in the second state the top surface of the track pointer is concave in shape.

5. The keyboard of claim 3, wherein the track pointer further comprises:
a plurality of ratchet members collectively operable to configure the track pointer between the first state and the second state in response to receiving the user input via the human appendage, the plurality of ratchet members maintaining the track pointer in the first state or the second state until a next user input via the human appendage is received.

6. The keyboard of claim 1, wherein the touchpad comprises an optical touch sensor.

7. The keyboard of claim 1, wherein the touchpad comprises a capacitive touch sensor.

8. The keyboard of claim 7, wherein the capacitive touch sensor comprises a plurality of capacitive sensing elements integrated with a planar material defining a top surface of the track pointer.

9. The keyboard of claim 7, wherein:
in the first state the top surface of the track pointer is convex in shape;
in the second state the top surface of the track pointer is concave in shape;
the planar material of the track pointer comprises an elastomer material; and
the capacitive touch sensor further comprises at least one flex circuit configured to maintain electrical conductivity between the plurality of capacitive sensing elements and at least one controller that processes signals generated by the capacitive sensing elements through repeated changes of the track pointer between the first state and the second state.

10. The keyboard of claim 7, wherein the capacitive touch sensor comprises a flex printed circuit board comprising a plurality of capacitive sensing elements disposed at an end of the flex printed circuit board, wherein the flex printed circuit board is rolled into a spiral shape, and the end of the flex printed circuit board at which the plurality of capacitive sensing elements are disposed is positioned at or near the top of the track pointer.

11. The keyboard of claim 10, wherein the flex printed circuit board further comprises at least one controller that processes signals generated by the capacitive sensing elements.

12. A track pointer comprising:
a touchpad;
wherein:
the track pointer is operable in at least two states;
in a first of the states, the touchpad is activated to detect movement of a human appendage across the touchpad or above the touchpad and generate a corresponding first signal that causes corresponding movement of a cursor presented on a display; and
in a second of the states, the touchpad is deactivated, and the track pointer is configured to detect movement of the track pointer by the human appendage and generate a corresponding second signal that causes corresponding movement of the cursor presented on the display.

13. The track pointer of claim 12, wherein:
in the first state, the track pointer remains at least substantially stationary with respect to horizontal movement when movement of the human appendage across or above the touchpad occurs; and
in the second state the track pointer is free to pivot with respect to a pivot point, and pivoting of the track pointer is detected by a track pointer encoder to generate the corresponding second signal.

14. The track pointer of claim 12, wherein the track pointer is configured to receive a user input via the human appendage to operate the track pointer between the first state and the second state.

15. The track pointer of claim 14, wherein:
in the first state the top surface of the track pointer is convex in shape; and
in the second state the top surface of the track pointer is concave in shape.

16. The track pointer of claim 14, further comprising:
a plurality of ratchet members collectively operable to configure the track pointer between the first state and the second state in response to receiving the user input via the human appendage, the plurality of ratchet members maintaining the track pointer in the first state or the second state until a next user input via the human appendage is received.

17. The track pointer of claim 12, wherein:
the touchpad comprises a capacitive touch sensor comprising a plurality of capacitive sensing elements integrated with a planar material defining a top surface of the track pointer;
in the first state the top surface of the track pointer is convex in shape;
in the second state the top surface of the track pointer is concave in shape;
the planar material of the track pointer comprises an elastomer material; and
the capacitive touch sensor further comprises at least one flex circuit configured to maintain electrical conductivity between the plurality of capacitive sensing elements and at least one controller that processes signals generated by the capacitive sensing elements through repeated changes of the track pointer between the first state and the second state.

18. The track pointer of claim 12, wherein:
the touchpad comprises a capacitive touch sensor comprising a flex printed circuit board comprising a plurality of capacitive sensing elements disposed at an end of the flex printed circuit board, wherein the flex printed circuit board is rolled into a spiral shape, and the end of the flex printed circuit board at which the plurality of capacitive sensing elements are disposed is positioned at or near the top of the track pointer.

19. A method of operating a track pointer, comprising:
in a first state, activating a touchpad of the track pointer to detect movement of a human appendage across the touchpad or above the touchpad and generate a corresponding first signal that causes corresponding movement of a cursor presented on a display;
receiving a user input changing the track pointer from the first state to a second state; and
in the second state, deactivating the touchpad and configuring the track pointer to detect movement of the track pointer by the human appendage and generate a corresponding second signal that causes corresponding movement of the cursor presented on the display.

20. The method of claim 19, wherein:
in the first state, the track pointer remains at least substantially stationary with respect to horizontal movement when movement of the human appendage across or above the touchpad occurs; and
in the second state the track pointer is free to pivot with respect to a pivot point, and pivoting of the track pointer is detected by a track pointer encoder to generate the corresponding second signal.

21. The method of claim 19, wherein:
in the first state the top surface of the track pointer is convex in shape; and
in the second state the top surface of the track pointer is concave in shape.
